(19) United States
(12) Patent Application Publication
(10) Pub. No.: US 2024/0257210 A1
(43) Pub. Date: Aug. 1, 2024

(54) SYSTEMS AND METHODS FOR ANALYZING AND DISPLAYING ITEM RECOMMENDATIONS

(71) Applicant: Walmart Apollo, LLC, Bentonville, AR (US)

(72) Inventors: Shiqin Cai, Mountain View, CA (US); Sinduja Subramaniam, San Jose, CA (US); Yijie Cao, Harrison, NJ (US); Rahul Sridhar, Santa Clara, CA (US); Evren Korpeoglu, San Jose, CA (US); Kannan Achan, Saratoga, CA (US)

(73) Assignee: Walmart Apollo, LLC, Bentonville, AR (US)

(21) Appl. No.: 18/103,229

(22) Filed: Jan. 30, 2023

(51) Int. Cl. G06Q 30/0601

(52) U.S. Cl. CPC G06Q 30/0631; G06Q 30/0633; G06Q 30/0641

(57) ABSTRACT

Systems and methods including one or more processors and one or more non-transitory computer readable media storing computing instructions that, when executed on the one or more processors, cause the one or more processors to perform: receiving historical interaction information corresponding to a user in a marketplace; identifying a shopping journey and a basket type for the user based on the cart context and items in a cart for the user for a current user session; identifying a price threshold for the cart for the user; building a machine learning model for the current user session in real-time based on the historical interaction information, the cart context, the basket type and the price threshold to determine a ranking of new items to display to the user to add to the cart for the current user session, wherein the new items satisfy the price threshold; re-ranking the ranking of the new items to display to the user in the current user session based on item attributes of the new items; and transmitting the re-ranked ranking of the new items to the user via a graphical user interface (GUI) during the current user session. Other embodiments are disclosed.

### TECHNICAL FIELD

This disclosure relates generally to computing system management, and more particularly to systems and methods for analyzing and displaying item recommendations.

### BACKGROUND

Online orders often include items that are frequently re-ordered. In many orders, more than half of the items are re-ordered items. Re-ordering such items generally involves browsing through multiple pages on a website to locate and add such items to an online order, which can be time-consuming. Additionally, users may forget some of the items that they would prefer to re-order.

### BRIEF DESCRIPTION OF THE DRAWINGS

To facilitate further description of the embodiments, the following drawings are provided in which:

FIG. 1 illustrates a front elevational view of a computer system that is suitable for implementing various embodiments of the systems disclosed in FIG. 3;

FIG. 2 illustrates a representative block diagram of an example of the elements included in the circuit boards inside a chassis of the computer system of FIG. 1;

FIG. 3 illustrates a representative block diagram of a system, according to an embodiment;

FIG. 4 illustrates a flowchart for a method, according to certain embodiments;

FIG. 5 illustrates an exemplary matrix factorization, according to certain embodiments;

FIG. 6 illustrates an exemplary user interface, according to certain embodiments; and

FIG. 7 illustrates an exemplary system architecture, according to certain embodiments.

For simplicity and clarity of illustration, the drawing figures illustrate the general manner of construction, and descriptions and details of well-known features and techniques may be omitted to avoid unnecessarily obscuring the present disclosure. Additionally, elements in the drawing figures are not necessarily drawn to scale. For example, the dimensions of some of the elements in the figures may be exaggerated relative to other elements to help improve understanding of embodiments of the present disclosure. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the apparatus, methods, and/or articles of manufacture described herein are, for example, capable of operation in other orientations than those illustrated or otherwise described herein.

The terms “couple,” “coupled,” “couples,” “coupling,” and the like should be broadly understood and refer to connecting two or more elements mechanically and/or otherwise. Two or more electrical elements may be electrically coupled together, but not be mechanically or otherwise coupled together. Coupling may be for any length of time, e.g., permanent or semi-permanent or only for an instant. “Electrical coupling” and the like should be broadly understood and include electrical coupling of all types. The absence of the word “removably,” “removable,” and the like near the word “coupled,” and the like does not mean that the coupling, etc. in question is or is not removable.

As defined herein, two or more elements are “integral” if they are comprised of the same piece of material. As defined herein, two or more elements are “non-integral” if each is comprised of a different piece of material.

As defined herein, “real-time” can, in some embodiments, be defined with respect to operations carried out as soon as practically possible upon occurrence of a triggering event. A triggering event can include receipt of data necessary to execute a task or to otherwise process information. Because of delays inherent in transmission and/or in computing speeds, the term “real time” encompasses operations that occur in “near” real time or somewhat delayed from a triggering event. In a number of embodiments, “real time” can mean real time less a time delay for processing (e.g., determining) and/or transmitting data. The particular time delay can vary depending on the type and/or amount of the data, the processing speeds of the hardware, the transmission capability of the communication hardware, the transmission distance, etc. However, in many embodiments, the time delay can be less than approximately one second, two seconds, five seconds, or ten seconds.

As defined herein, “approximately” can, in some embodiments, mean within plus or minus ten percent of the stated value. In other embodiments, “approximately” can mean within plus or minus five percent of the stated value. In further embodiments, “approximately” can mean within plus or minus three percent of the stated value. In yet other embodiments, “approximately” can mean within plus or minus one percent of the stated value.

### DESCRIPTION OF EXAMPLES OF EMBODIMENTS

A number of embodiments can include a system. The system can include one or more processors and one or more non-transitory computer-readable storage devices storing computing instructions. The computing instructions can be configured to run on the one or more processors and cause the one or more processors to perform: receiving historical interaction information corresponding to a user in a marketplace; identifying a shopping journey and a basket type for the user based on the cart context and items in a cart for the user for a current user session; identifying a price threshold for the cart for the user; building a machine learning model for the current user session in real-time based on the historical interaction information, the cart context, the basket type and the price threshold to determine a ranking of new items to display to the user to add to the cart for the current user session, wherein the new items satisfy the price threshold; re-ranking the ranking of the new items to display to the user in the current user session based on item attributes of the new items; and transmitting the re-ranked ranking of the new items to the user via a graphical user interface (GUI) during the current user session.

Various embodiments include a method. The method can be implemented via execution of computing instructions configured to run at one or more processors and configured to be stored at non-transitory computer-readable media. The method can comprise receiving historical interaction information corresponding to a user in a marketplace; identifying a shopping journey and a basket type for the user based on the cart context and items in a cart for the user for a current user session; identifying a price threshold for the cart for the user; building a machine learning model for the current user session in real-time based on the historical interaction information, the cart context, the basket type and the price threshold to determine a ranking of new items to display to the user to add to the cart for the current user session, wherein the new items satisfy the price threshold; re-ranking the ranking of the new items to display to the user in the current user session based on item attributes of the new items; and transmitting the re-ranked ranking of the new items to the user via a graphical user interface (GUI) during the current user session.

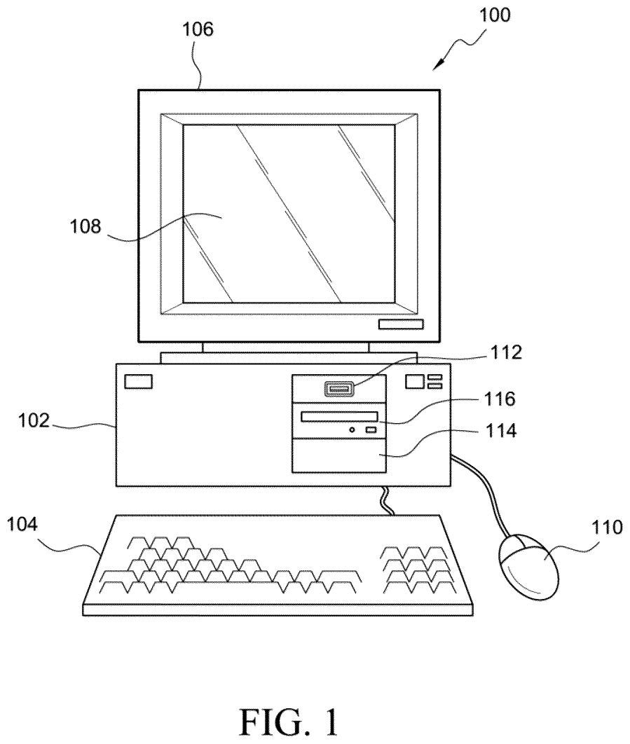

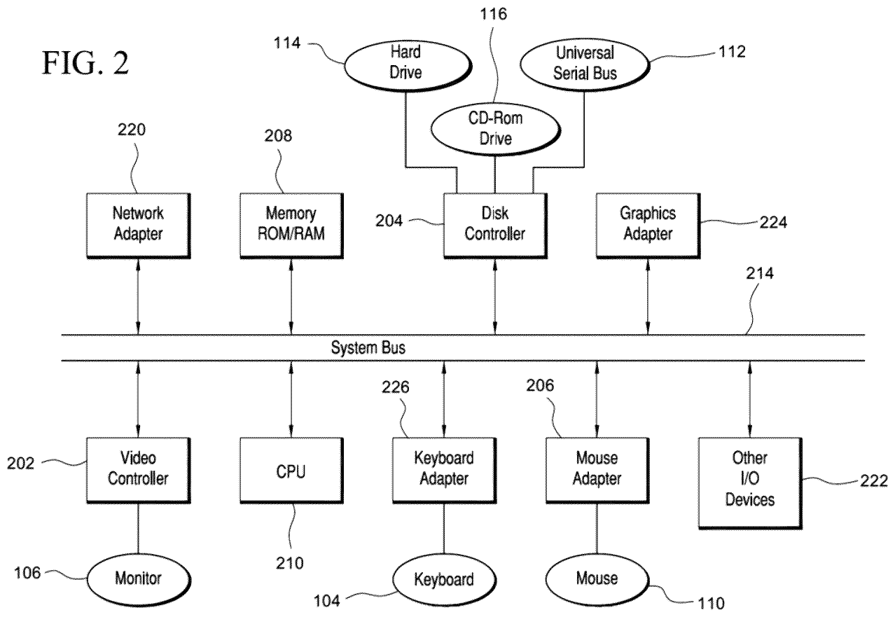

Turning to the drawings, FIG. 1 illustrates an exemplary embodiment of a computer system 100, all of which or a portion of which can be suitable for (i) implementing part or all of one or more embodiments of the techniques, methods, and systems and/or (ii) implementing and/or operating part or all of one or more embodiments of the memory storage modules described herein. As an example, a different or separate one of a chassis 102 (and its internal components) can be suitable for implementing part or all of one or more embodiments of the techniques, methods, and/or systems described herein. Furthermore, one or more elements of computer system 100 (e.g., a monitor 106, a keyboard 104, and/or a mouse 110, etc.) also can be appropriate for implementing part or all of one or more embodiments of the techniques, methods, and/or systems described herein. Computer system 100 can comprise chassis 102 containing one or more circuit boards (not shown), a Universal Serial Bus (USB) port 112, a Compact Disc Read-Only Memory (CD-ROM) and/or Digital Video Disc (DVD) drive 116, and a hard drive 114. A representative block diagram of the elements included on the circuit boards inside chassis 102 is shown in FIG. 2. A central processing unit (CPU) 210 in FIG. 2 is coupled to a system bus 214 in FIG. 2. In various embodiments, the architecture of CPU 210 can be compliant with any of a variety of commercially distributed architecture families.

Continuing with FIG. 2, system bus 214 also is coupled to a memory storage unit 208, where memory storage unit 208 can comprise (i) non-volatile memory, such as, for example, read only memory (ROM) and/or (ii) volatile memory, such as, for example, random access memory (RAM). The non-volatile memory can be removable and/or non-removable non-volatile memory. Meanwhile, RAM can include dynamic RAM (DRAM), static RAM (SRAM), etc. Further, ROM can include mask-programmed ROM, programmable ROM (PROM), one-time programmable ROM (OTP), erasable programmable read-only memory (EPROM), electrically erasable programmable ROM (EEPROM) (e.g., electrically alterable ROM (EAROM) and/or flash memory), etc. In these or other embodiments, memory storage unit 208 can comprise (i) non-transitory memory and/or (ii) transitory memory.

In many embodiments, all or a portion of memory storage unit 208 can be referred to as memory storage module(s) and/or memory storage device(s). In various examples, portions of the memory storage module(s) of the various embodiments disclosed herein (e.g., portions of the non-volatile memory storage module(s)) can be encoded with a boot code sequence suitable for restoring computer system 100 (FIG. 1) to a functional state after a system reset. In addition, portions of the memory storage module(s) of the various embodiments disclosed herein (e.g., portions of the non-volatile memory storage module(s)) can comprise microcode such as a Basic Input-Output System (BIOS) operable with computer system 100 (FIG. 1). In the same or different examples, portions of the memory storage module(s) of the various embodiments disclosed herein (e.g., portions of the non-volatile memory storage module(s)) can comprise an operating system, which can be a software program that manages the hardware and software resources of a computer and/or a computer network. The BIOS can initialize and test components of computer system 100 (FIG. 1) and load the operating system. Meanwhile, the operating system can perform basic tasks such as, for example, controlling and allocating memory, prioritizing the processing of instructions, controlling input and output devices, facilitating networking, and managing files. Exemplary operating systems can comprise one of the following: (i) Microsoft® Windows® operating system (OS) by Microsoft Corp. of Redmond, Washington, United States of America, (ii) Mac® OS X by Apple Inc. of Cupertino, California, United States of America, (iii) UNIX® OS, and (iv) Linux® OS. Further exemplary operating systems can comprise one of the following: (i) the iOS® operating system by Apple Inc. of Cupertino, California, United States of America, (ii) the Blackberry® operating system by Research In Motion (RIM) of Waterloo, Ontario, Canada, (iii) the WebOS operating system by LG Electronics of Seoul, South Korea, (iv) the Android™ operating system developed by Google, of Mountain View, California, United States of America, (v) the Windows Mobile™ operating system by Microsoft Corp. of Redmond, Washington, United States of America, or (vi) the Symbian™ operating system by Accenture PLC of Dublin, Ireland.

As used herein, “processor” and/or “processing module” means any type of computational circuit, such as but not limited to a microprocessor, a microcontroller, a controller, a complex instruction set computing (CISC) microprocessor, a reduced instruction set computing (RISC) microprocessor, a very long instruction word (VLIW) microprocessor, a graphics processor, a digital signal processor, or any other type of processor or processing circuit capable of performing the desired functions. In some examples, the one or more processing modules of the various embodiments disclosed herein can comprise CPU 210.

Alternatively, or in addition to, the systems and procedures described herein can be implemented in hardware, or a combination of hardware, software, and/or firmware. For example, one or more application specific integrated circuits (ASICs) can be programmed to carry out one or more of the systems and procedures described herein. For example, one or more of the programs and/or executable program components described herein can be implemented in one or more ASICs. In many embodiments, an application specific integrated circuit (ASIC) can comprise one or more processors or microprocessors and/or memory blocks or memory storage.

In the depicted embodiment of FIG. 2, various I/O devices such as a disk controller 204, a graphics adapter 224, a video controller 202, a keyboard adapter 226, a mouse adapter 206, a network adapter 220, and other I/O devices 222 can be coupled to system bus 214. Keyboard adapter 226 and mouse adapter 206 are coupled to keyboard 104 (FIGS. 1-2) and mouse 110 (FIGS. 1-2), respectively, of computer system 100 (FIG. 1). While graphics adapter 224 and video controller 202 are indicated as distinct units in FIG. 2, video controller 202 can be integrated into graphics adapter 224, or vice versa in other embodiments. Video controller 202 is suitable for monitor 106 (FIGS. 1-2) to display images on a screen 108 (FIG. 1) of computer system 100 (FIG. 1). Disk controller 204 can control hard drive 114 (FIGS. 1-2), USB port 112 (FIGS. 1-2), and CD-ROM drive 116 (FIGS. 1-2). In other embodiments, distinct units can be used to control each of these devices separately.

Network adapter 220 can be suitable to connect computer system 100 (FIG. 1) to a computer network by wired communication (e.g., a wired network adapter) and/or wireless communication (e.g., a wireless network adapter). In some embodiments, network adapter 220 can be plugged or coupled to an expansion port (not shown) in computer system 100 (FIG. 1). In other embodiments, network adapter 220 can be built into computer system 100 (FIG. 1). For example, network adapter 220 can be built into computer system 100 (FIG. 1) by being integrated into the motherboard chipset (not shown), or implemented via one or more dedicated communication chips (not shown), connected through a PCI (peripheral component interconnector) or a PCI express bus of computer system 100 (FIG. 1) or USB port 112 (FIG. 1).

Returning now to FIG. 1, although many other components of computer system 100 are not shown, such components and their interconnection are well known to those of ordinary skill in the art. Accordingly, further details concerning the construction and composition of computer system 100 and the circuit boards inside chassis 102 are not discussed herein.

Meanwhile, when computer system 100 is running, program instructions (e.g., computer instructions) stored on one or more of the memory storage module(s) of the various embodiments disclosed herein can be executed by CPU 210 (FIG. 2). At least a portion of the program instructions, stored on these devices, can be suitable for carrying out at least part of the techniques and methods described herein.

Further, although computer system 100 is illustrated as a desktop computer in FIG. 1, there can be examples where computer system 100 may take a different form factor while still having functional elements similar to those described for computer system 100. In some embodiments, computer system 100 may comprise a single computer, a single server, or a cluster or collection of computers or servers, or a cloud of computers or servers. Typically, a cluster or collection of servers can be used when the demand on computer system 100 exceeds the reasonable capability of a single server or computer. In certain embodiments, computer system 100 may comprise a portable computer, such as a laptop computer. In certain other embodiments, computer system 100 may comprise a mobile electronic device, such as a smartphone. In certain additional embodiments, computer system 100 may comprise an embedded system.

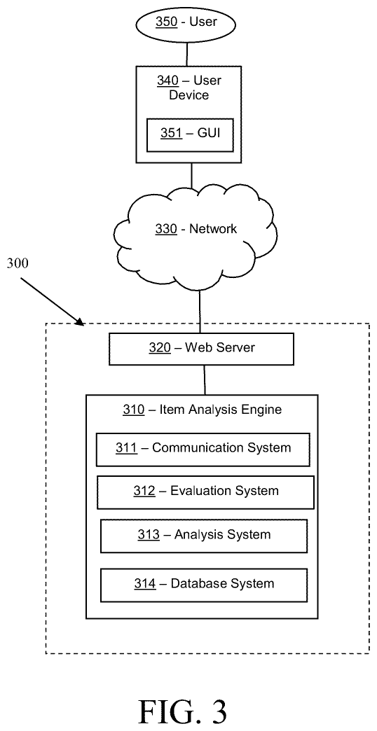

Turning ahead in the drawings, FIG. 3 illustrates a block diagram of a system 300 that can be employed for analyzing and displaying item recommendations, according to an embodiment. System 300 is merely exemplary and embodiments of the system are not limited to the embodiments presented herein. The system can be employed in many different embodiments or examples not specifically depicted or described herein. In some embodiments, certain elements, modules, or systems of system 300 can perform various procedures, processes, and/or activities. In other embodiments, the procedures, processes, and/or activities can be performed by other suitable elements, modules, or systems of system 300. In some embodiments, system 300 can include a item analysis engine 310 and/or web server 320.

Generally, therefore, system 300 can be implemented with hardware and/or software, as described herein. In some embodiments, part or all of the hardware and/or software can be conventional, while in these or other embodiments, part or all of the hardware and/or software can be customized (e.g., optimized) for implementing part or all of the functionality of system 300 described herein.

Item analysis engine 310 and/or web server 320 can each be a computer system, such as computer system 100 (FIG. 1), as described above, and can each be a single computer, a single server, or a cluster or collection of computers or servers, or a cloud of computers or servers. In another embodiment, a single computer system can host item analysis engine 310 and/or web server 320. Additional details regarding item analysis engine 310 and/or web server 320 are described herein.

In some embodiments, web server 320 can be in data communication through a network 330 with one or more user devices, such as a user device 340, which also can be part of system 300 in various embodiments. User device 340 can be part of system 300 or external to system 300. Network 330 can be the Internet or another suitable network. In some embodiments, user device 340 can be used by users, such as a user 350. In many embodiments, web server 320 can host one or more websites and/or mobile application servers. For example, web server 320 can host a website, or provide a server that interfaces with an application (e.g., a mobile application), on user device 340, which can allow users (e.g., 350) to interact with infrastructure components in an IT environment, in addition to other suitable activities. In a number of embodiments, web server 320 can interface with item analysis engine 310 when a user (e.g., 350) is viewing infrastructure components in order to assist with the analysis of the infrastructure components.

In some embodiments, an internal network that is not open to the public can be used for communications between item analysis engine 310 and web server 320 within system 300. Accordingly, in some embodiments, item analysis engine 310 (and/or the software used by such systems) can refer to a back end of system 300 operated by an operator and/or administrator of system 300, and web server 320 (and/or the software used by such systems) can refer to a front end of system 300, as is can be accessed and/or used by one or more users, such as user 350, using user device 340. In these or other embodiments, the operator and/or administrator of system 300 can manage system 300, the processor(s) of system 300, and/or the memory storage unit(s) of system 300 using the input device(s) and/or display device(s) of system 300.

In certain embodiments, the user devices (e.g., user device 340) can be desktop computers, laptop computers, mobile devices, and/or other endpoint devices used by one or more users (e.g., user 350). A mobile device can refer to a portable electronic device (e.g., an electronic device easily conveyable by hand by a person of average size) with the capability to present audio and/or visual data (e.g., text, images, videos, music, etc.). For example, a mobile device can include at least one of a digital media player, a cellular telephone (e.g., a smartphone), a personal digital assistant, a handheld digital computer device (e.g., a tablet personal computer device), a laptop computer device (e.g., a notebook computer device, a netbook computer device), a wearable user computer device, or another portable computer device with the capability to present audio and/or visual data (e.g., images, videos, music, etc.). Thus, in many examples, a mobile device can include a volume and/or weight sufficiently small as to permit the mobile device to be easily conveyable by hand. For examples, in some embodiments, a mobile device can occupy a volume of less than or equal to approximately 1790 cubic centimeters, 2434 cubic centimeters, 2876 cubic centimeters, 4056 cubic centimeters, and/or 5752 cubic centimeters. Further, in these embodiments, a mobile device can weigh less than or equal to 15.6 Newtons, 17.8 Newtons, 22.3 Newtons, 31.2 Newtons, and/or 44.5 Newtons.

Further still, the term “wearable user computer device” as used herein can refer to an electronic device with the capability to present audio and/or visual data (e.g., text, images, videos, music, etc.) that is configured to be worn by a user and/or mountable (e.g., fixed) on the user of the wearable user computer device (e.g., sometimes under or over clothing; and/or sometimes integrated with and/or as clothing and/or another accessory, such as, for example, a hat, eyeglasses, a wrist watch, shoes, etc.). In many examples, a wearable user computer device can comprise a mobile electronic device, and vice versa. However, a wearable user computer device does not necessarily comprise a mobile electronic device, and vice versa.

In specific examples, a wearable user computer device can comprise a head mountable wearable user computer device (e.g., one or more head mountable displays, one or more eyeglasses, one or more contact lenses, one or more retinal displays, etc.) or a limb mountable wearable user computer device (e.g., a smart watch). In these examples, a head mountable wearable user computer device can be mountable in close proximity to one or both eyes of a user of the head mountable wearable user computer device and/or vectored in alignment with a field of view of the user.

In more specific examples, a head mountable wearable user computer device can comprise (i) Google Glass™ product or a similar product by Google Inc. of Menlo Park, California, United States of America; (ii) the Eye Tap™ product, the Laser Eye Tap™ product, or a similar product by ePI Lab of Toronto, Ontario, Canada, and/or (iii) the Raptyr™ product, the STAR 1200™ product, the Vuzix Smart Glasses M100™ product, or a similar product by Vuzix Corporation of Rochester, New York, United States of America. In other specific examples, a head mountable wearable user computer device can comprise the Virtual Retinal Display™ product, or similar product by the University of Washington of Seattle, Washington, United States of America. Meanwhile, in further specific examples, a limb mountable wearable user computer device can comprise the iWatch™ product, or similar product by Apple Inc. of Cupertino, California, United States of America, the Galaxy Gear or similar product of Samsung Group of Samsung Town, Seoul, South Korea, the Moto 360 product or similar product of Motorola of Schaumburg, Illinois, United States of America, and/or the Zip™ product, One™ product, Flex™ product, Charge™ product, Surge™ product, or similar product by Fitbit Inc. of San Francisco, California, United States of America.

Exemplary mobile devices can include (i) an iPod®, iPhone®, iTouch®, iPad®, MacBook® or similar product by Apple Inc. of Cupertino, California, United States of America, (ii) a Blackberry® or similar product by Research in Motion (RIM) of Waterloo, Ontario, Canada, (iii) a Lumia® or similar product by the Nokia Corporation of Keilaniemi, Espoo, Finland, and/or (iv) a Galaxy™ or similar product by the Samsung Group of Samsung Town, Seoul, South Korea. Further, in the same or different embodiments, a mobile device can include an electronic device configured to implement one or more of (i) the iPhone® operating system by Apple Inc. of Cupertino, California, United States of America, (ii) the Blackberry® operating system by Research In Motion (RIM) of Waterloo, Ontario, Canada, (iii) the Android™ operating system developed by the Open Handset Alliance, or (iv) the Windows Mobile™ operating system by Microsoft Corp. of Redmond, Washington, United States of America.

In many embodiments, item analysis engine 310 and/or web server 320 can each include one or more input devices (e.g., one or more keyboards, one or more keypads, one or more pointing devices such as a computer mouse or computer mice, one or more touchscreen displays, a microphone, etc.), and/or can each comprise one or more display devices (e.g., one or more monitors, one or more touch screen displays, projectors, etc.). In these or other embodiments, one or more of the input device(s) can be similar or identical to keyboard 104 (FIG. 1) and/or a mouse 110 (FIG. 1). Further, one or more of the display device(s) can be similar or identical to monitor 106 (FIG. 1) and/or screen 108 (FIG. 1). The input device(s) and the display device(s) can be coupled to item analysis engine 310 and/or web server 320 in a wired manner and/or a wireless manner, and the coupling can be direct and/or indirect, as well as locally and/or remotely. As an example of an indirect manner (which may or may not also be a remote manner), a keyboard-video-mouse (KVM) switch can be used to couple the input device(s) and the display device(s) to the processor(s) and/or the memory storage unit(s). In some embodiments, the KVM switch also can be part of item analysis engine 310 and/or web server 320. In a similar manner, the processors and/or the non-transitory computer-readable media can be local and/or remote to each other.

Meanwhile, in many embodiments, item analysis engine 310 and/or web server 320 also can be configured to communicate with one or more databases, such as a database system 314. The one or more databases can include historical interaction information, user activity information, and/or machine learning training data, for example, among other data as described herein. The one or more databases can be stored on one or more memory storage units (e.g., non-transitory computer readable media), which can be similar or identical to the one or more memory storage units (e.g., non-transitory computer readable media) described above with respect to computer system 100 (FIG. 1). Also, in some embodiments, for any particular database of the one or more databases, that particular database can be stored on a single memory storage unit or the contents of that particular database can be spread across multiple ones of the memory storage units storing the one or more databases, depending on the size of the particular database and/or the storage capacity of the memory storage units.

The one or more databases can each include a structured (e.g., indexed) collection of data and can be managed by any suitable database management systems configured to define, create, query, organize, update, and manage database(s). Exemplary database management systems can include MySQL (Structured Query Language) Database, PostgreSQL Database, Microsoft SQL Server Database, Oracle Database, SAP (Systems, Applications, & Products) Database, and IBM DB2 Database.

Meanwhile, item analysis engine 310, web server 320, and/or the one or more databases can be implemented using any suitable manner of wired and/or wireless communication. Accordingly, system 300 can include any software and/or hardware components configured to implement the wired and/or wireless communication. Further, the wired and/or wireless communication can be implemented using any one or any combination of wired and/or wireless communication network topologies (e.g., ring, line, tree, bus, mesh, star, daisy chain, hybrid, etc.) and/or protocols (e.g., personal area network (PAN) protocol(s), local area network (LAN) protocol(s), wide area network (WAN) protocol(s), cellular network protocol(s), powerline network protocol(s), etc.). Exemplary PAN protocol(s) can include Bluetooth, Zigbee, Wireless Universal Serial Bus (USB), Z-Wave, etc.; exemplary LAN and/or WAN protocol(s) can include Institute of Electrical and Electronic Engineers (IEEE) 802.3 (also known as Ethernet), IEEE 802.11 (also known as WiFi), etc.; and exemplary wireless cellular network protocol(s) can include Global System for Mobile Communications (GSM), General Packet Radio Service (GPRS), Code Division Multiple Access (CDMA), Evolution-Data Optimized (EV-DO), Enhanced Data Rates for GSM Evolution (EDGE), Universal Mobile Telecommunications System (UMTS), Digital Enhanced Cordless Telecommunications (DECT), Digital AMPS (IS-136/Time Division Multiple Access (TDMA)), Integrated Digital Enhanced Network (iDEN), Evolved High-Speed Packet Access (HSPA+), Long-Term Evolution (LTE), WiMAX, etc. The specific communication software and/or hardware implemented can depend on the network topologies and/or protocols implemented, and vice versa. In many embodiments, exemplary communication hardware can include wired communication hardware including, for example, one or more data buses, such as, for example, universal serial bus(es), one or more networking cables, such as, for example, coaxial cable(s), optical fiber cable(s), and/or twisted pair cable(s), any other suitable data cable, etc. Further exemplary communication hardware can include wireless communication hardware including, for example, one or more radio transceivers, one or more infrared transceivers, etc. Additional exemplary communication hardware can include one or more networking components (e.g., modulator-demodulator components, gateway components, etc.).

In many embodiments, item analysis engine 310 can include a communication system 311, an evaluation system 312, an analysis system 313, and/or database system 314. In many embodiments, the systems of item analysis engine 310 can be modules of computing instructions (e.g., software modules) stored at non-transitory computer readable media that operate on one or more processors. In other embodiments, the systems of item analysis engine 310 can be implemented in hardware. Item analysis engine 310 and/or web server 320 each can be a computer system, such as computer system 100 (FIG. 1), as described above, and can be a single computer, a single server, or a cluster or collection of computers or servers, or a cloud of computers or servers. In another embodiment, a single computer system can host item analysis engine 310 and/or web server 320. Additional details regarding item analysis engine 310 and the components thereof are described herein.

In many embodiments, user device 340 can comprise graphical user interface (“GUI”) 351. In the same or different embodiments, GUI 351 can be part of and/or displayed by user computer 340, which also can be part of system 300. In some embodiments, GUI 351 can comprise text and/or graphics (image) based user interfaces. In the same or different embodiments, GUI 351 can comprise a heads up display (“HUD”). When GUI 351 comprises a HUD, GUI 351 can be projected onto a medium (e.g., glass, plastic, etc.), displayed in midair as a hologram, or displayed on a display (e.g., monitor 106 (FIG. 1)). In various embodiments, GUI 351 can be color, black and white, and/or greyscale. In many embodiments, GUI 351 can comprise an application running on a computer system, such as computer system 100 (FIG. 1), user computers 340. In the same or different embodiments, GUI 351 can comprise a website accessed through internet 320. In some embodiments, GUI 351 can comprise an eCommerce website. In these or other embodiments, GUI 351 can comprise an administrative (e.g., back end) GUI allowing an administrator to modify and/or change one or more settings in system 300. In the same or different embodiments, GUI 351 can be displayed as or on a virtual reality (VR) and/or augmented reality (AR) system or display. In some embodiments, an interaction with a GUI can comprise a click, a look, a selection, a grab, a view, a purchase, a bid, a swipe, a pinch, a reverse pinch, etc.

In some embodiments, web server 320 can be in data communication through network (e.g., Internet) 330 with user computers (e.g., 340). In certain embodiments, user computers 340 can be desktop computers, laptop computers, smart phones, tablet devices, and/or other endpoint devices. Web server 320 can host one or more websites. For example, web server 320 can host an eCommerce website that allows users to browse and/or search for products, to add products to an electronic shopping cart, and/or to purchase products, in addition to other suitable activities.

In many embodiments, item analysis engine 310, and/or web server 320 can each comprise one or more input devices (e.g., one or more keyboards, one or more keypads, one or more pointing devices such as a computer mouse or computer mice, one or more touchscreen displays, a microphone, etc.), and/or can each comprise one or more display devices (e.g., one or more monitors, one or more touch screen displays, projectors, etc.). In these or other embodiments, one or more of the input device(s) can be similar or identical to keyboard 104 (FIG. 1) and/or a mouse 110 (FIG. 1). Further, one or more of the display device(s) can be similar or identical to monitor 106 (FIG. 1) and/or screen 108 (FIG. 1). The input device(s) and the display device(s) can be coupled to the processing module(s) and/or the memory storage module(s) of item analysis engine 310, and/or web server 320 in a wired manner and/or a wireless manner, and the coupling can be direct and/or indirect, as well as locally and/or remotely. As an example of an indirect manner (which may or may not also be a remote manner), a keyboard-video-mouse (KVM) switch can be used to couple the input device(s) and the display device(s) to the processing module(s) and/or the memory storage module(s). In some embodiments, the KVM switch also can be part of item analysis engine 310, and/or web server 320. In a similar manner, the processing module(s) and the memory storage module(s) can be local and/or remote to each other.

In many embodiments, item analysis engine 310, and/or web server 320 can be configured to communicate with one or more user computers 340. In some embodiments, user computers 340 also can be referred to as customer computers. In some embodiments, item analysis engine 310, and/or web server 320 can communicate or interface (e.g., interact) with one or more customer computers (such as user computers 340) through a network or internet 330. Internet 330 can be an intranet that is not open to the public. In further embodiments, Internet 330 can be a mesh network of individual systems. Accordingly, in many embodiments, item analysis engine 310, and/or web server 320 (and/or the software used by such systems) can refer to a back end of system 300 operated by an operator and/or administrator of system 300, and user computers 340 (and/or the software used by such systems) can refer to a front end of system 300 used by one or more users 350, respectively. In some embodiments, users 350 can also be referred to as customers, in which case, user computers 340 can be referred to as customer computers. In these or other embodiments, the operator and/or administrator of system 300 can manage system 300, the processing module(s) of system 300, and/or the memory storage module(s) of system 300 using the input device(s) and/or display device(s) of system 300.

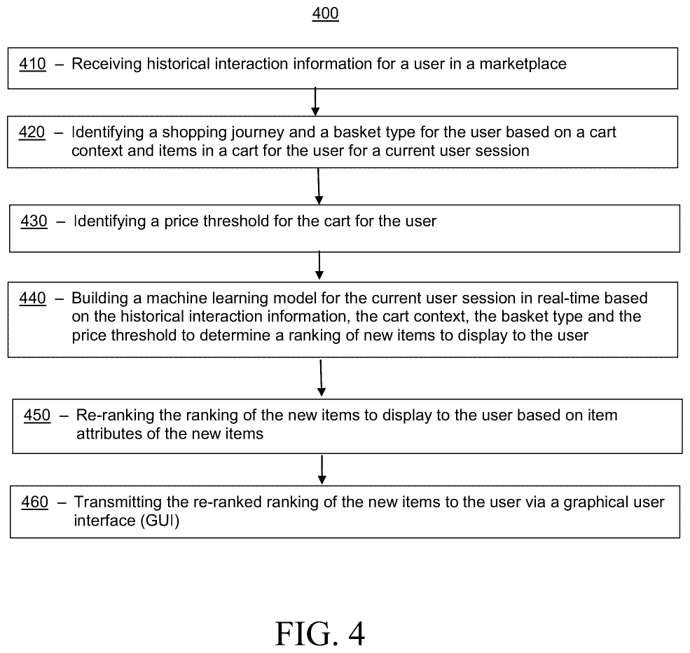

Turning ahead in the drawings, FIG. 4 illustrates a flow chart for a method 400, according to an embodiment. Method 400 is merely exemplary and is not limited to the embodiments presented herein. Method 400 can be employed in many different embodiments or examples not specifically depicted or described herein. In some embodiments, the activities of method 400 can be performed in the order presented. In other embodiments, the activities of method 400 can be performed in any suitable order. In still other embodiments, one or more of the activities of method 400 can be combined or skipped. In many embodiments, system 300 (FIG. 3) can be suitable to perform method 400 and/or one or more of the activities of method 400. In these or other embodiments, one or more of the activities of method 400 can be implemented as one or more computer instructions configured to run at one or more processing modules and configured to be stored at one or more non-transitory memory storage modules. Such non-transitory memory storage modules can be part of a computer system such as item analysis engine 310, web server 320, and/or user device 340 (FIG. 3). The processing module(s) can be similar or identical to the processing module(s) described above with respect to computer system 100 (FIG. 1).

In many embodiments, method 400 can comprise an activity 410 of receiving historical interaction information corresponding to a user in a marketplace. In some embodiments, the historical interaction information can include add-to-carts, orders, or impressions for products previously interacted with by the user. In some embodiments, the historical interaction information can include online transactions and in-store transactions made by the user occurring before the present time. In many embodiments, the previous transactions can be stored in a database along with the times/dates of the orders of the online transactions and/or the in-store transactions. In some embodiments, a set of previous transactions of the user and/or other users can include online transactions and in-store transactions transacted within a set period of time. In many embodiments, the online transactions and the in-store transactions can be accumulated and/or saved within a database based on a period of time. In several embodiments, the set of items stored can be periodically updated to display relevant and/or current favorite items personal to the user. In various embodiments, the data accumulated and stored within the database can be used for current training data for machine learning approaches and/or determining a probability identifying the items to be ordered on specific times on specific days. For example, after each transaction on a given time of day, the set of items for each user can be automatically updated to add the transaction information to a database. In some embodiments, one or more machine learning models can be utilized to perform the method of 400.

In many embodiments, method 400 can comprise an activity 420 of identifying a shopping journey type and a basket type for the user based on items in a cart for the user for a current user session. In some embodiments, the type of shopping journey and the basket type can be based on a cart context (e.g., information corresponding to a number of items in the cart for the user). In some embodiments, identifying the cart context further comprises analyzing the items in the cart to determine if the shopping journey is one of the following: routine corresponding to routinely purchased items (e.g., toilet paper, paper plates, groceries, etc.), non-routine corresponding to items that are not routinely purchased (e.g., electronics, furniture, etc.), or mixed corresponding to items that are routinely purchased and items that are not routinely purchased. In some embodiments, the routine and non-routine items are based on the historical interaction information for the user. In other embodiments, the routine and non-routine items are based on the historical interaction information for two or more users. Alternatively, the routine and non-routine items can be identified by an operator of the marketplace. For example, the operator can determine which product types correspond to routine items and which product types correspond to non-routine items. In some embodiments, identifying the basket type further comprises analyzing the items in the cart to determine if the basket type is one of the following: online pickup and delivery (OPD) corresponding to items that are eligible for pickup and delivery by the marketplace, shipping corresponding to items that are eligible for delivery by a distribution center of a third party, or split corresponding to items that are OPD and items that are shipping.

In many embodiments, method 400 can comprise an activity 430 of identifying a price threshold for the cart for the user. In some embodiments, the price threshold for the cart can be a price range for the eligible items. In some embodiments, identifying the price threshold for the eligible items for the user can include determining a current total price for the items in the cart for the user, identifying an upper limit price threshold (e.g., free shipping), and identifying the price threshold (e.g., target price range) as a difference between the current total price and the upper limit price threshold. In some embodiments, the price threshold is utilized to reduce a number of products that need to be analyzed by a machine learning engine. For example, activity 430 can include identifying a current total price in the user's cart and how that price relates to a free shipping threshold (e.g., how much more is required for the user to reach a free shipping dollar value). For example, the items in the user's cart can add up to $25, and the free shipping threshold is $30. As such, activity 430 can identify that the recommended items can be in a price group of $5-$6 each. This allows activity 430 to reduce the size of items that are analyzed by a machine learning model. For example, products outside of the price group do not need to be processed by the machine learning engine.

In many embodiments, method 400 can comprise an activity 440 of building a machine learning model for the current user session in real-time based on the historical interaction information, the cart context, the basket type and the price threshold to determine a ranking of new items to display to the user. In particular, activity 440 can include building the machine learning model for the current user session in real-time based on the historical interaction information, the cart context, the basket type and the price threshold to determine the ranking of new items to display to the user to add to the cart for the current user session, where the new items satisfy the price threshold.

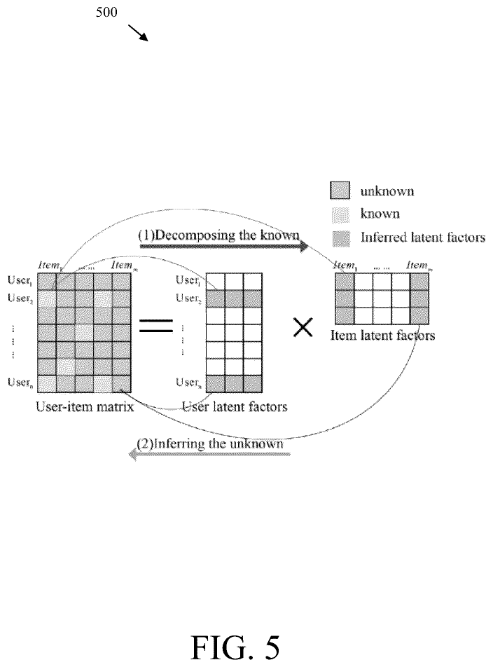

In some embodiments, activity 440 can include building a user-item interaction matrix based on the historical interaction information. In some embodiments, the historical interaction information includes view, click, add-to-cart and item transaction information. In some embodiments, this user-item interaction matrix is utilized to derive user and item embeddings using matrix factorization. Turning briefly to FIG. 5, an exemplary matrix factorization 500 is illustrated showing how the user-item matrix is used in matrix factorization.

Returning to FIG. 4, activity 440 can include building a price sensitive Weighted Alternate Least Squares (WALS) model to determine item embeddings. In some embodiments, building the price sensitive WALS model to determine item embeddings can include building a first price sensitive WALS model to determine item embeddings for routine items, and building a second price sensitive WALS model to determine item embeddings for non-routine items.

In some embodiments, the WALS models are built by optimizing the following loss function:

$$\begin{matrix}L = {\sum }_{u = 1}^{M} {\sum }_{i = 1}^{N} {{w}_{ui} ( {r}_{ui} - {p}_{u}^{T} {q}_{j} )}^{2} + λ ( {\sum }_{u = 1}^{M} {‖ {p}_{u} ‖}^{2} + {\sum }_{i = 1}^{N} {‖ {q}_{i} ‖}^{2} ) \\ = {‖ W ⊙ ( R - {PQ}^{T} ) ‖}^{2} + λ ( {‖ P ‖}^{2} + {‖ Q ‖}^{2} ) ,\end{matrix}$$

$$Subject to {w}_{ui} = \{ \begin{matrix}{c}_{ui} & if ( u , i ) ∈ ℛ , \\ {c}_{0} & if ( u , i ) ∉ ℛ ,\end{matrix}$$

where L corresponds to a loss function, R is the user-item matrix, P_{ε}R^{M×K} denotes the latent factor matrix for user embeddings, Q_{ε}R^{M×K} corresponds to the latent factor matrix for item embeddings, λ corresponds to a hyper-parameter to control the regularization strength to prevent overfitting, wᵤᵢ corresponds to the weigh of the training instance rᵤᵢ, W_{ε}R^{M×N} is the matrix form for all weights wᵤᵢ, cᵤᵢ corresponds to the weight of observed entry (u, i), and c₀ corresponds to the uniform weight for all missing entries.

In some embodiments, activity 440 can include identifying the first price sensitive WALS model for a cart context of routine items, identifying the second price sensitive WALS model for a cart context of non-routine items. For example, when the cart context is routine, activity 440 can build the machine learning model using the first price sensitive WALS model which is built on user-item interactions for routine items. In some embodiments, activity 440 can include identifying an output from the price sensitive WALS model. In some embodiments, the output includes a ranked list of the new items based on the price threshold from the users cart, the basket type, and the cart context. In some embodiments, activity 440 can include determining a filtered list of new items by removing a number of the new items based on the basket type of the user, and identifying a threshold number of items from each product type in the filtered list of new items. For example, the machine learning model for the current user session can be built on items in the price group of $5-$6 each. As detailed above, the user-item interaction matrix is built based on user purchase history. For example, the matrix correlates users to particular items. Subsequently, the separate Price Sensitive Weighted Alternate Least Squares (WALS) models are built to derive user and item embeddings for routine and non-routine items. For example, if the user cart context is routine, the method uses a first price sensitive WALS model for the routine items, and uses a second price sensitive WALS model for the non-routine items when the user cart context is non-routine. In some embodiments, a threshold number of items from one of the WALS models based on the basket type of the user is identified. For example, if the user has a basket type of OPD, activity 440 can obtain the top 30 items from the WALS model that are OPD eligible. In some embodiments, activity 440 can include identifying a threshold number of items from each product type (e.g., vegetables, beverages, etc.). For example, activity 440 can take the top 4 items from each product type. In some embodiments, the output is a ranked list of items based on the current user session information identified above.

In many embodiments, method 400 can comprise an activity 450 of re-ranking the ranking of the new items to display to the user based on item attributes of the new items. In various embodiments, the re-ranked items can be for displaying to the user in the current user session. In some embodiments, the item attributes include an inter-purchase interval (IPI) score for each of the new items, and an inventory status for each of the new items corresponding to each of the new items being in-stock or out-of-stock. In some embodiments, the IPI score corresponds to an item's re-purchase time window. For example, bananas can have an IPI of 7 days, which corresponds to an amount of time that a user is likely to wait before they repurchase bananas. In another example, a user may purchase paper plates every month and an IPI score for “paper plates” can be 30-days. In some embodiments, activity 450 can include removing items from the ranking of the new items that have an inventory status of out-of-stock because the user will not be able to purchase these items, and removing items from the ranking of the new items that are in the cart for the user for the current user session because the user is already prepared to purchase these items. In some embodiments, activity 450 can include, after the two removing steps, re-ranking the ranking of the new items based on the IPI score by ranking the new items with a lower IPI score higher on the ranking of the new items. For example, the IPI score corresponds to the number of days that the product will be re-purchased based on the last time the user purchased the item. For example, paper plates can have an IPI score of 30 days, the user can purchase paper plates, and the IPI score can be reset to 30. In some embodiments, the IPI score can decrease. For example, day 1 is a high IPI score because paper plate has an IPI score of 30, and day 28 is a low IPI score because it is closer to the end of the 30-day time window to re-purchase the paper plate. As such, activity 450 can re-rank the items to have items with a higher IPI score lower on the list of recommended items.

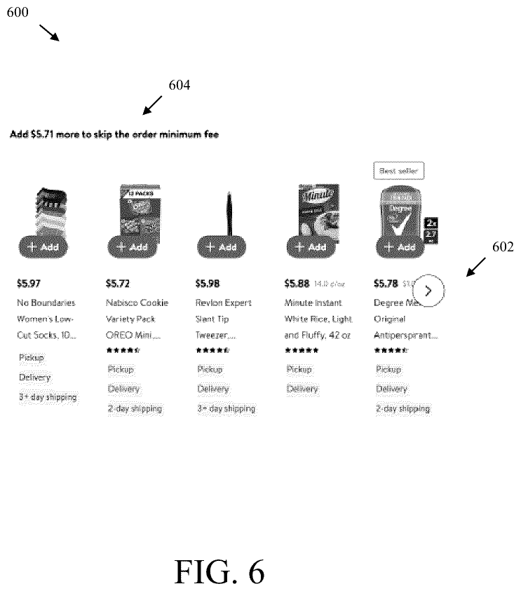

In many embodiments, method 400 can comprise an activity 460 of transmitting the re-ranked ranking of the new items to the user via a graphical user interface (GUI). In various embodiments, the transmission can occur via the GUI during the current user session. In some embodiments, activity 460 can comprise including a first subset of the re-ranked ranking of the new items in a first portion of the GUI; and including remaining ones of the re-ranked ranking of the new items in a second portion of the GUI that the user can access via interaction with a button of the GUI. Turning briefly to FIG. 6, an exemplary user interface 600 is illustrated that includes a first subset of the re-ranked items. In the illustrated embodiment of FIG. 6, the user interface 600 includes a button 602 that allows the user to access the remaining ones of the re-ranked items. For example, interaction with the button 602 updates the user interface 600 in a carousel-type manner to allow the user to access all of the re-ranked new items being displayed. In the illustrated embodiment, the user interface 600 also includes a status indicator 604, which indicates that price threshold remaining for the user to obtain free shipping, for example. In some embodiments, when the user adds one of the products from the user interface 600 to their cart, the status indicator 604 can update to display a message that the price threshold has been satisfied (e.g., free shipping obtained).

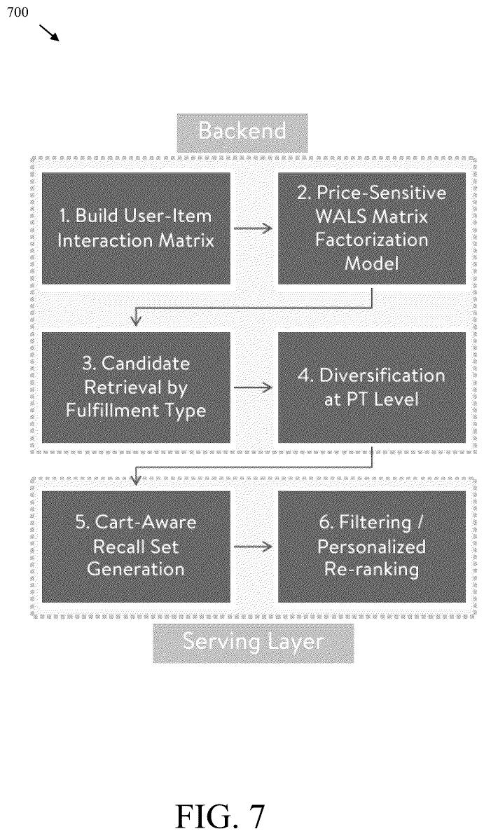

Turning to FIG. 7, an exemplary system architecture 700 is illustrated. The system architecture 700 includes a backend server and a serving layer. The backend server implements activities 410, 420, 430, and 440 (FIG. 4) to build the machine learning model to be utilized by the serving layer. In some embodiments, the serving layer implements activities 450 and 460 (FIG. 4). The system architecture 700 utilizes the backend server to build and train the machine learning model, which improves the operation of the serving layer.

Returning to FIG. 3, in several embodiments, communication system 311 can at least partially perform activity 410 (FIG. 4), and/or activity 460 (FIG. 4).

In several embodiments, evaluation system 312 can at least partially perform activity 420 (FIG. 4), and/or activity 430 (FIG. 4), and/or activity 440 (FIG. 4).

In a number of embodiments, analysis system 313 can at least partially perform activity 450 (FIG. 4).

In a number of embodiments, web server 320 can at least partially perform method 400.

As an overview of various embodiments described herein, a customized on-line shopping experience can be implemented by (1) building a user-item interaction matrix based on recent customer session data, (2) building one or more separate WALS models to derive user and item embeddings for routine and non-routine items, (3) selecting the top N items from each model per fulfillment type for each customer, (4) selecting a maximum of K items from each product type for item diversification, (5) retrieving recall set items from the corresponding model(s) given a cart context, and (6) filtering the items based on item availability and re-ranking the items based on inter-purchase intervals.

In a number of embodiments, the techniques described herein can solve a technical problem that arises only within the realm of computer networks, as online orders do not exist outside the realm of computer networks. Generally, an average time a user spends online building a basket (e.g., virtual cart) to complete an online order can take thirty (30) to fifty (50) minutes due to the time-consuming task of selecting items on several different webpages and the computer resources used to navigate (e.g., search) several pages during a visit to a website, which could include, for example, navigating several hundred pages per visit. For example, if a user adds forty-five (45) items in a basket during an online session, that user can browse many more pages exceeding the actual number of items added to a basket. During each visit to a website for a single online session, testing has indicated that a user often selects more than half of the items previously ordered and/or regularly ordered in a basket. Previously ordered items can include items with expiration dates or consumption dates (e.g., fruit and other perishable food items, toiletries, cleaning products, and other such suitable item regularly ordered) that are personalized to that user. Additionally, a user often adds new items to a basket, which can involve further computer resources to continue browsing multiple webpages and selecting each new item to add to the order. By using an item analysis engine, a system can effectively predict a number of re-order items the user can select with a single option (e.g., click) which can beneficially result in a reduction in processor use and memory cache, among other things.

Moreover, the techniques described herein can solve a technical problem that cannot be solved outside the context of computer networks. Specifically, the techniques described herein cannot be used outside the context of computer networks, in view of a lack of data, and because the item analysis engine cannot be performed without a computer.

In many embodiments, the techniques described herein can provide a practical application and several technological improvements In some embodiments, the techniques described herein can provide an automatic determination of a set of items by using a predictive model approach focusing on a propensity of a user to re-order based on at least a machine learning approach. These techniques described herein can provide a significant improvement over conventional approaches of subjectively searching for the same items to re-order that can expend a lot of time and computer resources, processors, and memory, to find each previously ordered item in a website (e.g., content catalog of webpages). These technological improvements can reveal information about the customer's potential shopping journey and preferences to different products and product categories, and the improvements also can be used to implement a price-sensitive and cart-aware item recommender system and method that is personalized by the customer's item preference and that also is sensitive to the customer's price sensitivity in the current shopping journey. For example, e-commerce customers who are near the free-shipping threshold may be motivated to add more products to the electronic shopping cart in order to qualify for free shipping, and the improvements can be used to implement a product recommender to allow such customers to choose to add more items to the cart to quality for free shipping before checking out.

In a number of embodiments, the techniques described herein can advantageously provide a consistent user experience by adapting to a constantly changing website that adds new items to website inventory (e.g., online catalogs) of which less than half of the basket can be newly added inventory. Further the techniques described herein can advantageously enable real-time data processing and increase the capability to select a list of items to recommend to a user each time the user builds a basket in real-time.

In many embodiments, the techniques described herein can be used regularly (e.g., hourly, daily, etc.) at a scale that cannot be handled using manual techniques. For example, the system tracks every item ordered for each of a number of users that can result in a number of individual daily visits to the website that can exceed one hundred million, and the number of registered users to the website can exceed ten million.

Although systems and methods for item analysis have been described with reference to specific embodiments, it will be understood by those skilled in the art that various changes may be made without departing from the spirit or scope of the disclosure. Accordingly, the disclosure of embodiments is intended to be illustrative of the scope of the disclosure and is not intended to be limiting. It is intended that the scope of the disclosure shall be limited only to the extent required by the appended claims. For example, to one of ordinary skill in the art, it will be readily apparent that any element of FIGS. 1-7 may be modified, and that the foregoing discussion of certain of these embodiments does not necessarily represent a complete description of all possible embodiments. For example, one or more of the procedures, processes, or activities of FIG. 4 may include different procedures, processes, and/or activities and be performed by many different modules, in many different orders.

All elements claimed in any particular claim are essential to the embodiment claimed in that particular claim. Consequently, replacement of one or more claimed elements constitutes reconstruction and not repair. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims, unless such benefits, advantages, solutions, or elements are stated in such claim.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

What is claimed is:

1. A system comprising:
one or more processors; and
one or more non-transitory computer-readable media storing computing instructions that, when executed on the one or more processors, perform:
receiving historical interaction information corresponding to a user in a marketplace;
identifying a shopping journey and a basket type for the user based on items in a cart for the user for a current user session;
identifying a price threshold for the cart for the user;
building a machine learning model for the current user session in real-time based on the historical interaction information, the shopping journey, the basket type and the price threshold to determine a ranking of new items to display to the user to add to the cart for the current user session, wherein the new items satisfy the price threshold;
re-ranking the ranking of the new items to display to the user in the current user session based on item attributes of the new items; and
transmitting the re-ranked ranking of the new items to the user via a graphical user interface (GUI) during the current user session.

2. The system of claim 1, wherein identifying the cart context further comprises analyzing the items in the cart to determine if the shopping journey is one of the following: routine corresponding to routinely purchased items, non-routine corresponding to items that are not routinely purchased, or mixed corresponding to items that are routinely purchased and items that are not routinely purchased.

3. The system of claim 1, wherein identifying the basket type further comprises analyzing the items in the cart to determine if the basket type is one of the following: online pickup and delivery (OPD) corresponding to items that are eligible for pickup and delivery by the marketplace, shipping corresponding to items that are eligible for delivery by a distribution center of a third party, or split corresponding to items that are OPD and items that are shipping.

4. The system of claim 1, wherein identifying the price threshold for the cart for the user further comprises:
determining a current total price for the items in the cart for the user;
identifying an upper limit price threshold; and
identifying the price threshold as a difference between the current total price and the shipping price threshold.

5. The system of claim 1, wherein building the machine learning model for the current user session in real-time further comprises:
building a user-item interaction matrix based on the historical interaction information, the historical interaction information including add-to-cart and item transaction information; and
building a price sensitive Weighted Alternate Least Squares (WALS) model to determine user/item embeddings.

6. The system of claim 5, wherein building the price sensitive WALS model to determine item embeddings further comprises:
building a first price sensitive WALS model to determine item embeddings for routine items;
building a second price sensitive WALS model to determine item embeddings for non-routine items;
identifying the first price sensitive WALS model for a cart context of routine items;
identifying the second price sensitive WALS model for a cart context of non-routine items; and
identifying a combination of the first price sensitive WALS model and the second price sensitive WALS model based on a cart context that includes routine and non-routine items.

7. The system of claim 5, further comprising:
identifying an output from the price sensitive WALS model, the output including a ranked list of the new items;
determining a filtered list of new items by removing a number of the new items based on the basket type of the user; and
identifying a threshold number of items from each product type in the filtered list of new items.

8. The system of claim 1, wherein the item attributes include an inter-purchase interval (IPI) score for each of the new items, and an inventory status for each of the new items corresponding to each of the new items being in-stock or out-of-stock.

9. The system of claim 8, wherein re-ranking the ranking of the new items to display to the user in the current user session based on the item attributes further comprises:
removing items from the ranking of the new items that have an inventory status of out-of-stock;
removing items from the ranking of the new items that are in the cart for the user for the current user session; and
after the two removing steps, re-ranking the ranking of remaining ones of the new items based on the IPI score by ranking the remaining ones of the new items with a higher IPI score higher on the ranking of the new items.

10. The system of claim 1, wherein transmitting the re-ranked ranking of the new items to the user via the GUI further comprises:
including a first subset of the re-ranked ranking of the new items in a first portion of the GUI; and
including remaining ones of the re-ranked ranking of the new items in a second portion of the GUI that the user can access via interaction with the GUI.

11. A method implemented via execution of computing instructions configured to run at one or more processors and configured to be stored at non-transitory computer-readable media, the method comprising:
receiving historical interaction information corresponding to a user in a marketplace;
identifying a shopping journey and a basket type for the user based on items in a cart for the user for a current user session;
identifying a price threshold for the cart for the user;
building a machine learning model for the current user session in real-time based on the historical interaction information, the shopping journey, the basket type and the price threshold to determine a ranking of new items to display to the user to add to the cart for the current user session, wherein the new items satisfy the price threshold;
re-ranking the ranking of the new items to display to the user in the current user session based on item attributes of the new items; and
transmitting the re-ranked ranking of the new items to the user via a graphical user interface (GUI) during the current user session.

12. The method of claim 11, wherein identifying the cart context further comprises analyzing the items in the cart to determine if the shopping journey is one of the following: routine corresponding to routinely purchased items, non-routine corresponding to items that are not routinely purchased, or mixed corresponding to items that are routinely purchased and items that are not routinely purchased.

13. The method of claim 11, wherein identifying the basket type further comprises analyzing the items in the cart to determine if the basket type is one of the following: online pickup and delivery (OPD) corresponding to items that are eligible for pickup and delivery by the marketplace, shipping corresponding to items that are eligible for delivery by a distribution center of a third party, or split corresponding to items that are OPD and items that are shipping.

14. The method of claim 11, wherein identifying the price threshold for the cart for the user further comprises:
determining a current total price for the items in the cart for the user;
identifying an upper limit price threshold; and
identifying the price threshold as a difference between the current total price and the shipping price threshold.

15. The method of claim 11, wherein building the machine learning model for the current user session in real-time further comprises:
building a user-item interaction matrix based on the historical interaction information, the historical interaction information including add-to-cart and item transaction information; and
building a price sensitive Weighted Alternate Least Squares (WALS) model to determine user/item embeddings.

16. The method of claim 15, wherein building the price sensitive WALS model to determine item embeddings further comprises:
building a first price sensitive WALS model to determine item embeddings for routine items;
building a second price sensitive WALS model to determine item embeddings for non-routine items;
identifying the first price sensitive WALS model for a cart context of routine items;
identifying the second price sensitive WALS model for a cart context of non-routine items; and
identifying a combination of the first price sensitive WALS model and the second price sensitive WALS model based on a cart context that includes routine and non-routine items.

17. The method of claim 15, further comprising:
identifying an output from the price sensitive WALS model, the output including a ranked list of the new items;
determining a filtered list of new items by removing a number of the new items based on the basket type of the user; and
identifying a threshold number of items from each product type in the filtered list of new items.

18. The method of claim 11, wherein the item attributes include an inter-purchase interval (IPI) score for each of the new items, and an inventory status for each of the new items corresponding to each of the new items being in-stock or out-of-stock.

19. The method of claim 18, wherein re-ranking the ranking of the new items to display to the user in the current user session based on the item attributes further comprises:
removing items from the ranking of the new items that have an inventory status of out-of-stock;
removing items from the ranking of the new items that are in the cart for the user for the current user session; and
after the two removing steps, re-ranking the ranking of remaining ones of the new items based on the IPI score by ranking the remaining ones of the new items with a higher IPI score higher on the ranking of the new items.

20. The method of claim 11, wherein transmitting the re-ranked ranking of the new items to the user via the GUI further comprises:
including a first subset of the re-ranked ranking of the new items in a first portion of the GUI; and
including remaining ones of the re-ranked ranking of the new items in a second portion of the GUI that the user can access via interaction with the GUI.
